(19) United States
(12) Patent Application Publication
(10) Pub. No.: US 2005/0188339 A1
(43) Pub. Date: Aug. 25, 2005

(54) System and method for navigating design information associated with an IC design

(76) Inventor: David Michael Anderson, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/786,828

(22) Filed: Feb. 25, 2004

(51) Int. Cl. G06F 17/50

(52) U.S. Cl. 716/11

(57) ABSTRACT

A system and method for navigating through design information associated with an integrated circuit (IC) design. A graphical user interface is presented upon launching a connectivity browser, wherein the connectivity browser is operable to traverse a text-based connectivity database that includes a plurality of design objects provided for the IC design. The text-based connectivity database or a portion thereof is interrogated via a command line interface portion of the graphical user interface by supplying at least a portion of a text-based indicium associated with a design object.

### BACKGROUND

Many integrated circuit (IC) devices, e.g., application specific integrated circuits (ASICs) or other custom IC devices, are designed and fabricated using a number of various computer-implemented automatic design processes. Within these processes, a high level design language description of the integrated circuit (e.g., using HDL, VHDL, Verilog, etc.) is first translated by a computer system into a netlist of generic logic. The generic logic can then be translated into a netlist of technology-specific gates and interconnections therebetween that represent the IC design. The netlist is, more specifically, a listing of circuit elements and their connectivity information and is stored within computer memory (as part of a design database environment) of the computer system.

To reduce costs and time to market, circuit designers have developed design libraries which contain numerous standard design objects grouped by specific function, along with known electrical operating characteristics and parametric values including, for example, resistance and capacitance. Standard cell libraries are illustrative of design libraries that contain commonly used medium-scale integration (MSI) structures such as decoders, registers, and counters and commonly used large-scale integration (LSI) structures such as memories, programmable logic arrays, and microprocessors. The circuit designer utilizes the standard cells and custom cells to design and optimize the layout of a circuit by, for example, reducing propagation delays and minimizing the size of the chip to increase the number of chips which can be fabricated on a single wafer.

It should therefore be appreciated that the connectivity information for today's VLSI IC designs can be quite voluminous, spanning several directories and sub-directories in a multi-file design database system. As a result, traversing such a design database for locating a particular circuit component for any reason can be very tedious as well as frustratingly confusing, even where the connectivity information is represented as a text-based embodiment. On the other hand, where the connectivity information is maintained as a graphical schematic of the IC design, obtaining visibility into particular components and their respective connectivity information is also unsatisfactory as only higher levels of a hierarchical design may be presented, which can obscure finer-scale connectivity information.

### SUMMARY

In one embodiment, a scheme is disclosed for navigating through design information associated with an IC design. A graphical user interface is presented upon launching a connectivity browser, wherein the connectivity browser is operable to traverse a text-based connectivity database that includes a plurality of design objects provided for the IC design. The text-based connectivity database or a portion thereof is interrogated via a command line interface portion of the graphical user interface by supplying at least a portion of a text-based indicium associated with a design object.

### BRIEF DESCRIPTION OF THE DRAWINGS

FIG. 1 depicts an embodiment of a top level design relating to an IC device;

FIG. 2 depicts an embodiment of a hierarchical collection of design objects with respect to a design;

FIG. 3 depicts an architectural embodiment of a connectivity browser engine for navigating through design information associated with an IC design;

FIG. 4 depicts an embodiment of a computer-implemented system for navigating through design information associated with an IC design;

FIGS. 5A-5G depict a number of screen shot renditions associated with a graphical user interface that is effectuated by launching a connectivity browser embodiment of the present invention; and

FIG. 6 depicts an embodiment of a computer-implemented method for navigating through design information associated with an IC design.

### DETAILED DESCRIPTION OF THE DRAWINGS

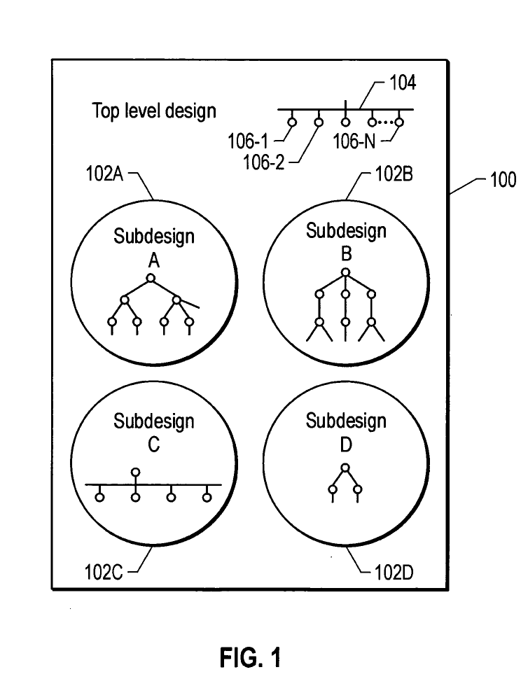

In the drawings, like or similar elements are designated with identical reference numerals throughout the several views thereof, and the various elements depicted are not necessarily drawn to scale. Referring now to FIG. 1, therein is depicted an embodiment of a top level design 100 relating to an IC device or at least a portion thereof. As is well-known, the top level IC design 100 may be provided as a computer-implemented multi-file database structure having a hierarchical netlist organization wherein one or more subdesigns contain design objects that are interfaced together in parent-child relationships including tertiary or other higher-level nesting. Further, the top level design 100 may also include subdesigns with a flattened connectivity architecture as well as local leaf cells directly used by the top level design 100.

For purposes of the present patent application, the top level design 100 may relate to any type of design library including, for example, standard cell libraries, custom design libraries, hybrid design libraries, et cetera, and the various entities having prescribed interface relationships therein will be referred to as design objects regardless of their hierarchical level. Reference numeral 102 A refers to a hierarchical design object, Subdesign A, that includes a plurality of lower level design objects. Likewise, each of Subdesign B 102B, Subdesign C 102C and Subdesign D 102D comprises a hierarchical design object that in turn includes additional lower level design objects which may be arranged in a tree fashion depending on the interfacing relationships imposed thereon. Reference numeral 104 refers to a number of local design objects 106-1 through 106-N of the top level design 100 that are disposed in a flat connectivity architecture.

Under the hierarchical representation set forth above, a design object may have one parent design and can include one or more child designs, wherein each design is provided with its own specific input/output (I/O) interfaces. All the design objects, from the top level design to the leaf cells located at the bottom of the hierarchy, include level-specific design data information (e.g., geometry and connectivity) that is used in the design of a particular IC device.

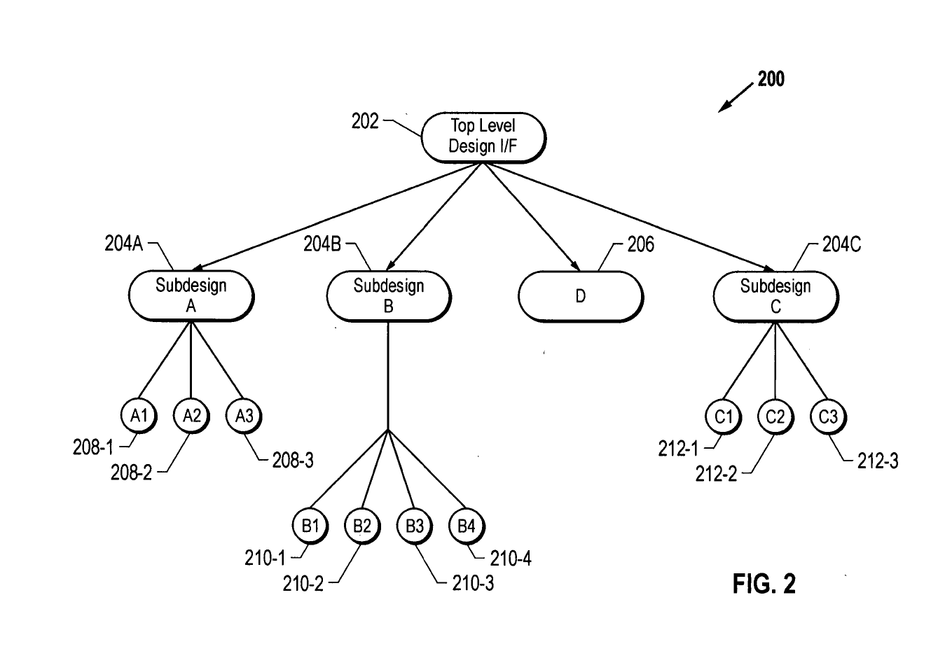

FIG. 2 depicts an embodiment of a hierarchical netlist 200 of a collection of design objects with respect to a design, such as, e.g., the top level design 100 described above. The netlist 200 represents a hierarchical tree organization of geometric information and connectivity information regarding the various design objects, wherein each design object has a specific I/O signal interface relationship. A top level circuit design netlist 202 contains references to Subdesign A 204A through Subdesign C 204C as well as Subdesign D 206. By so referencing, the top level circuit design includes all geometry and connectivity information contained within each Subdesign. By way of illustration, Subdesign A 204A contains three leaf objects A1, 208-1 through A3 208-3. Subdesign B 204B contains four leaf objects B1 210-1 through B4 210-4. Likewise, Subdesign C 204C contains reference to three leaf objects C1 212-1 through C 3 212-3. Each Subdesign as well as the top level circuit design can also include local geometry and interconnections (i.e., design structure) that represent circuitry logically situated within a Subdesign or the top level circuit design. It should be appreciated that each parent level design object (e.g., the top level circuit design 202 or any of the Subdesigns A through C) that references other child level design objects also contains connectivity information regarding the manner in which the child objects are interconnected together.

As alluded to hereinabove, the hierarchical design data information of an IC device may be graphically represented (depicting various circuit elements such as transistors, gates, latches, et cetera) as a schematic layout. Further, such design data may also be embodied in a text-based connectivity database where the signal names, I/O interfaces, design object names, and parent-child relationships are textually presented. In either representation, the corpus of a design database can be extremely unwieldy for today's VLSI designs, and may span across a rather extensive multi-file directory, thereby rendering any searching scheme to be cumbersome and inefficient. By way of example, a portion of a text-based connectivity netlist for a design object called BLOCK recsrcsel1 is shown below in a text-format:

BLOCK recsrcsel1;

PORTS NET:

GND (PORT_CLASS=”IMPLICIT”), VDD (PORT_CLASS=” IMPLICIT”),
dccstalldeth (DIR+”IN”), FPUSIRSTALLFP2H (DIR=”IN”),
ieurecsrcselrenh (DIR=”OUT”), ieuxbflushwb1h (DIR=”IN”),
spustallexeh (DIR=”IN”);

ENDPORTS
SIGNALS NET:

GND, VDD, dccstalldeth, fpusirstallfp2h, ieurecsrcselrenh,
ieuxbflushwb1h, recsrcselrenhx, spuorxbh, spustallexeh;

ENDSIGNALS
INSTANCES

scinvl_46:

drv (LOCATION=”25.00,8.50”, I_EXTENT=”25.00,8.50
28.00,10.50”);

scnor3_3:

selhx (LOCATION=”16.00,8.00”, I_EXTENT=”16.00,8.45
19.50,10.55”);

scor2_2:

spuorxbh (LOCATION=”8.00,8.50”, I_EXTENT=”8.00,8.50
11.50,10.50”);

ENDINSTANCES
SIGNALLIST

GND: THISBLOCK*GND, drv*GND, selhx*GND, spuorxbh*GND;
VDD: THISBLOCK*VDD, drv*VDD, selhx*VDD, spuorxbh*VDD;
dccstalldeth: THISBLOCK*dccstalldeth, selhx*a;
fpusirstallfp2h: THISBLOCK*fpusirstallfp2h, selhx*c;
ieurecsrcselrenh: THISBLOCK*ieurecsrcselrenh, drv*z;
ieuxbflushwb1h: THISBLOCK*ieuxbflushwb1h, spuorxbh*b;
recsrcselrenhx: drv*a, selhx*z;
spuorxbh: selhx*b, spuorxbh*z;
spustallexeh: THISBLOCK*spustallexeh, spuorxbh*a;

ENDSIGNALLIST
INSTANCELIST

THISBLOCK: GND=GND, VDD=VDD, dccstalldeth=dccstalldeth,

fpusirstallfp2h=fpusirstallfp2h,
ieurecsrcselrenh = ieurecsrcselrenh,
ieuxbflushwb1h=ieuxbflushwb1h,
spustallexeh=spustallexeh;

| drv: GND=GND, VDD=VDD, a=recsrcselrenhx, z=ieurecsrcselrenh; | |
|---|---|
| selhx: | GND=GND, VDD=VDD, a=dccstalldeth, b=spuorxbh, |
| | c=fpusirstallfp2h, z=recsrcselrenhx; |
| spuorxbh: | GND=GND, VDD=VDD, a=spustallexeh, |
| | b=ieuxbflushwb1h, z=spuorxbh; |

ENDINSTANCELIST

ENDBLOCK

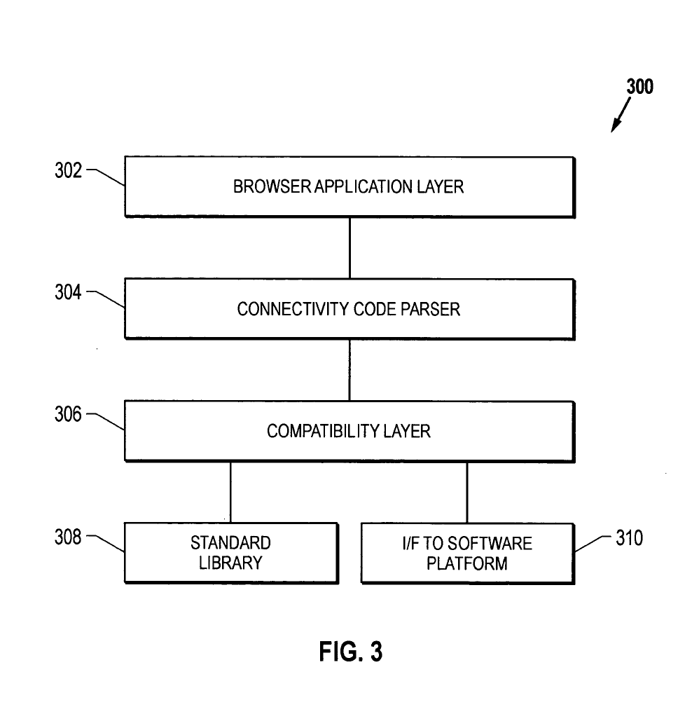

FIG. 3 depicts an architectural embodiment of a connectivity browser engine 300 for facilitating navigation in a design information database environment associated with an IC design. A browser application layer 302 is operable as a “presentation” layer to provide a user-friendly graphical user interface for maneuvering around and traversing the hierarchical arrangement of the various design objects provided for a particular IC design. As will be described in additional detail below, a number of menu-driven pop-up or pull-down dialog boxes, one or more command line interface portions and tool bars as well as partitioned screens or panes may be effectuated by the browser application layer 302 for providing an efficient and intuitively interactive navigational session to the user. A connectivity code parser 304 is operable—responsive to the command line entries—to parse the text-based connectivity information for identifying matching indicia (e.g., names of design objects such as cells and subcells, subcircuits and their instances, nets and blocks, signal names, port and wire lists, et cetera) and for providing any search/seek results to the browser application layer 302. An optional compatibility layer 306 may be provided as part of the connectivity browser engine 300 in order to support a variety of text-based connectivity database formats by offering a translation service between the connectivity code parser 304 and a particular text-based connectivity database (not shown in this FIGURE). An appropriate software interface 310 is provided as the bottom layer of the connectivity browser engine architecture 300 for interfacing with a host software platform that may be specific to the operation system (OS) of the host hardware. Furthermore, depending on how light or heavy the browser architecture needs to be, a standard library of utilities 308 may also be included therein, in addition to appropriately thinning or thickening the various layers of the overall architecture.

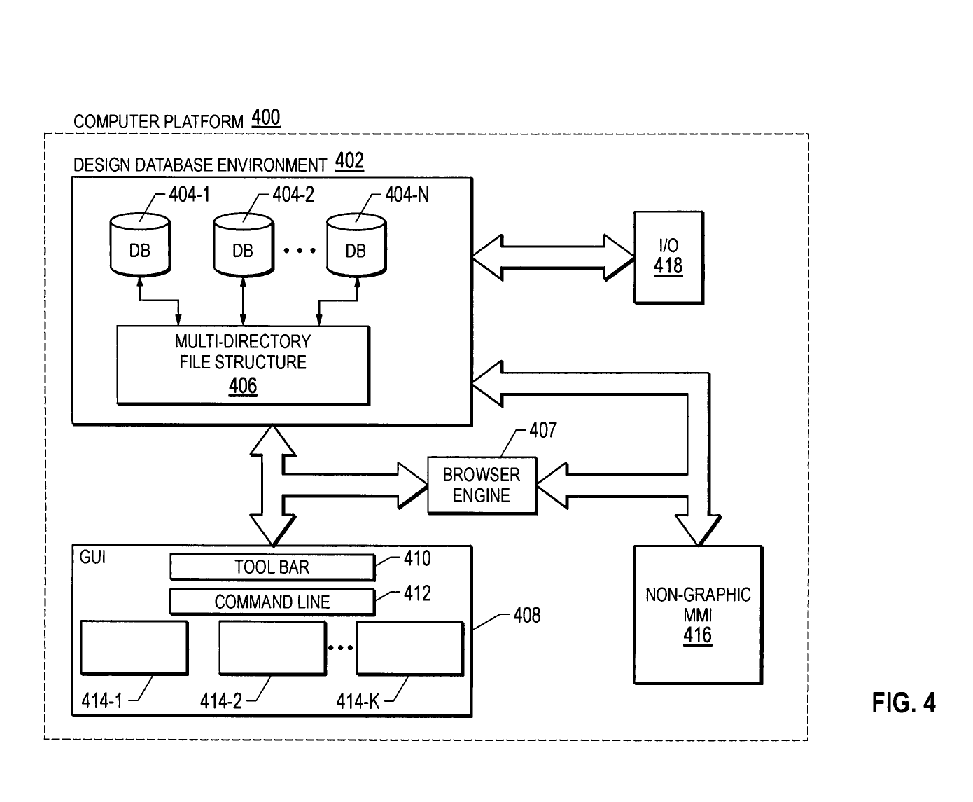

Referring now to FIG. 4, depicted therein is an embodiment of a computer-implemented system supported by a suitable computer platform 400 for navigating through design information associated with an IC design. For purposes of brevity, standard features of the computer platform 400 (such as, e.g., printer and other output devices, mass storage subsystems, internal processor-memory subsystems, et cetera) are not particularly shown in this rendition. A design database environment 402 supported by the computer platform 400 comprises a plurality of design databases 404-1 through 404-N that contain design information of an IC design, including text-based connectivity information relating to a number of design objects provided for the IC design. In one configuration, the text-based connectivity information may be embodied as a multi-directory file structure 406 pertaining to the hierarchical text-based data from one or more databases 404-1 through 404-N.

A graphical user interface (GUI) 408 is effectuated by a browser engine 407 having an architectural embodiment such as the browser architecture 300 described hereinabove. By way of illustration, GUI 408 includes one or more tool bars 410 having appropriate navigation-specific icons, a command line interface 412 for entering search categories, search queries, etc., as well as known or heretofore unknown GUI-based file system management icons or software buttons. A plurality of panes 414-1 through 414-K are provided for managing the presentation of search results, raw or processed reports, and the like. Reference numeral 416 refers to a generic man-machine interface other than a GUI, which can include devices such as keyboards, pointing devices, track balls and so on, and it is envisaged that any of these devices may be used in conjunction with the connectivity browser engine 407 for the purpose of facilitating navigation through the design database environment. A generic I/O 418 is also supported by the computer platform 400 in connection with the design database environment 402, whereby search results and reports may be saved to appropriate media, local or otherwise.

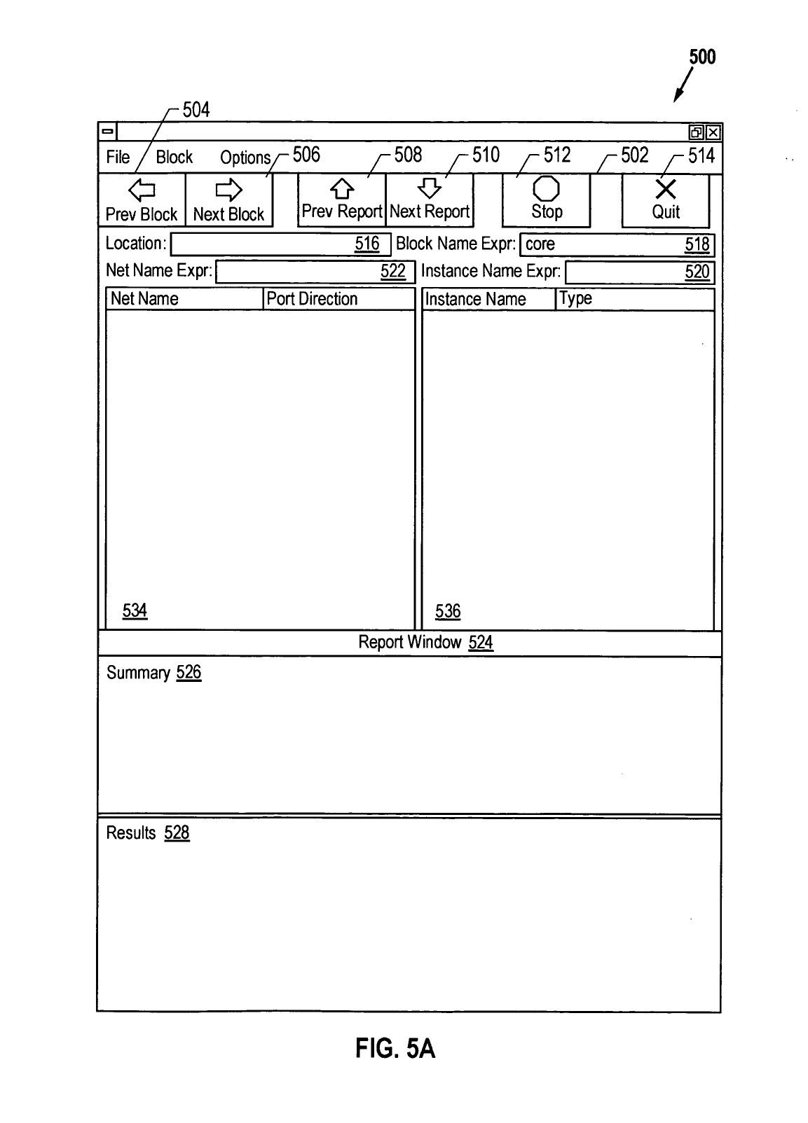

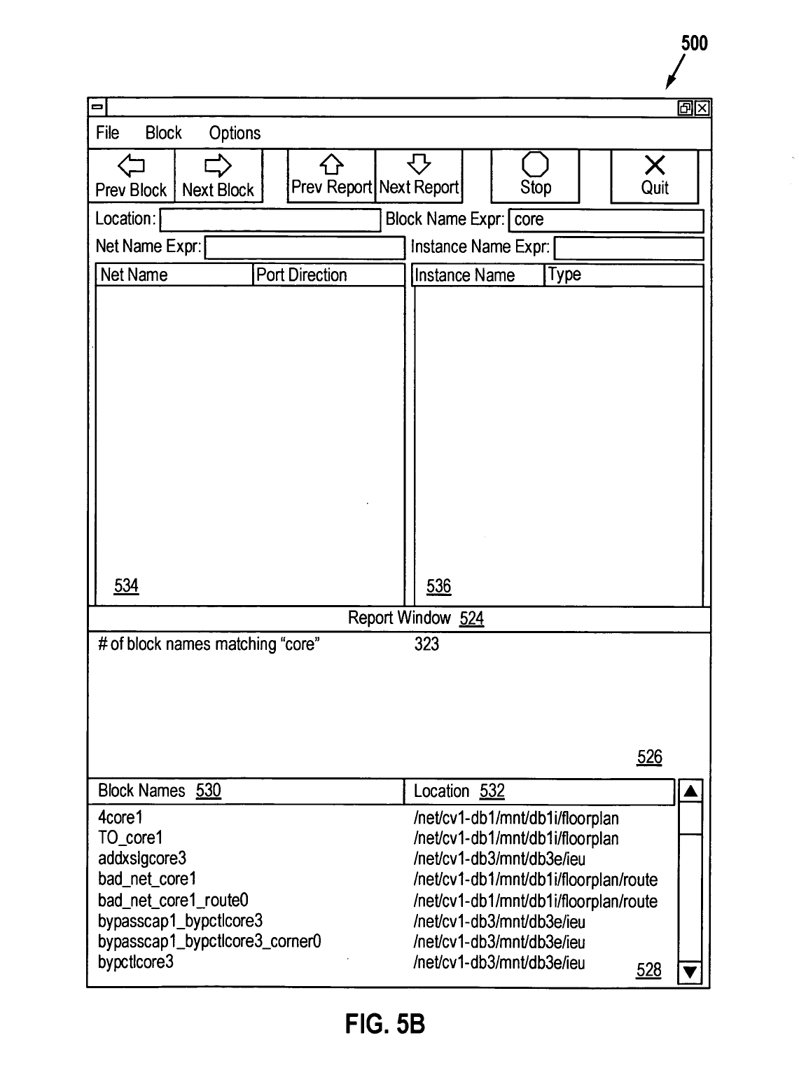

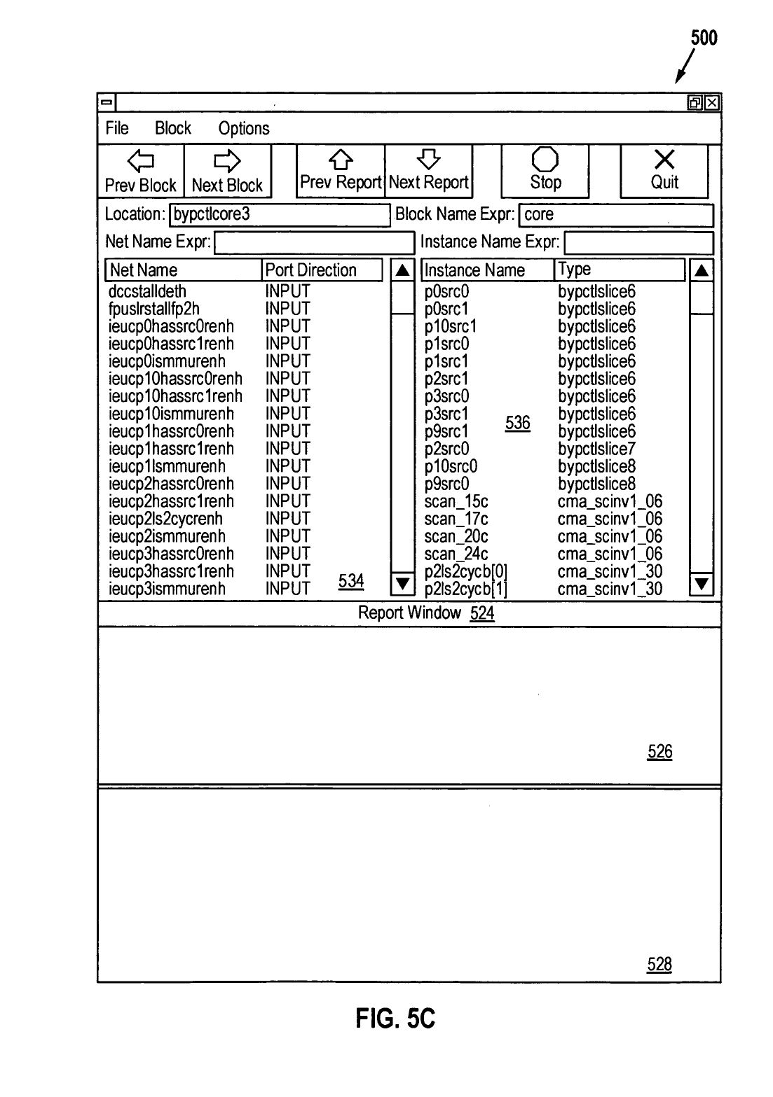

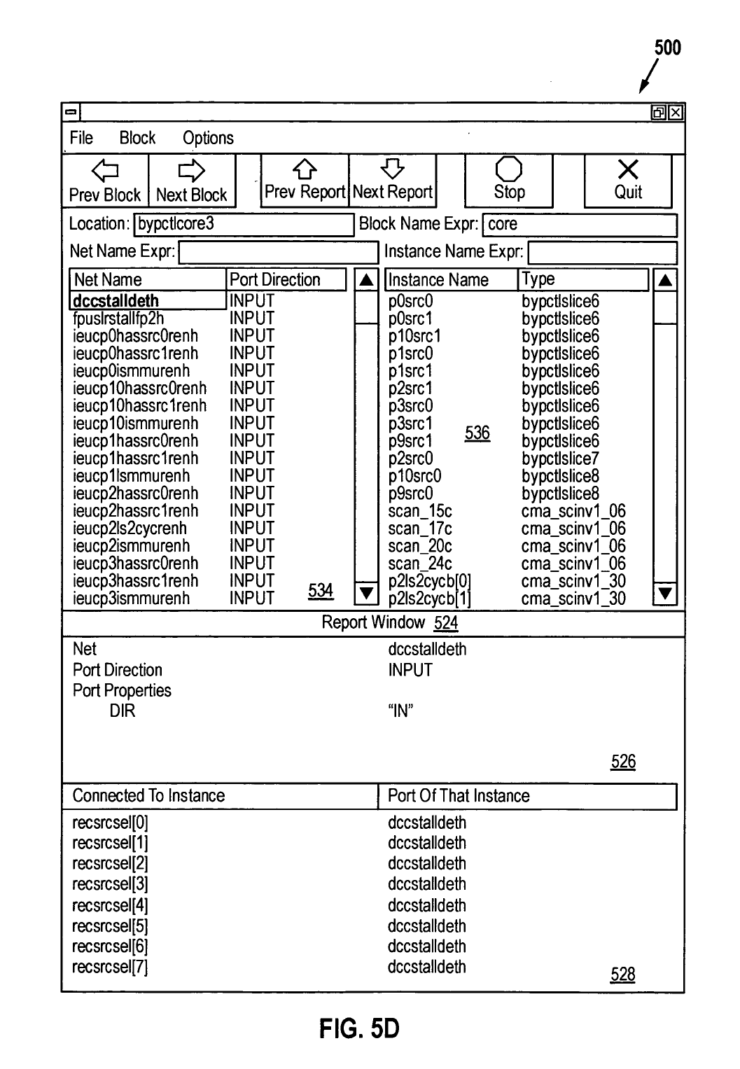

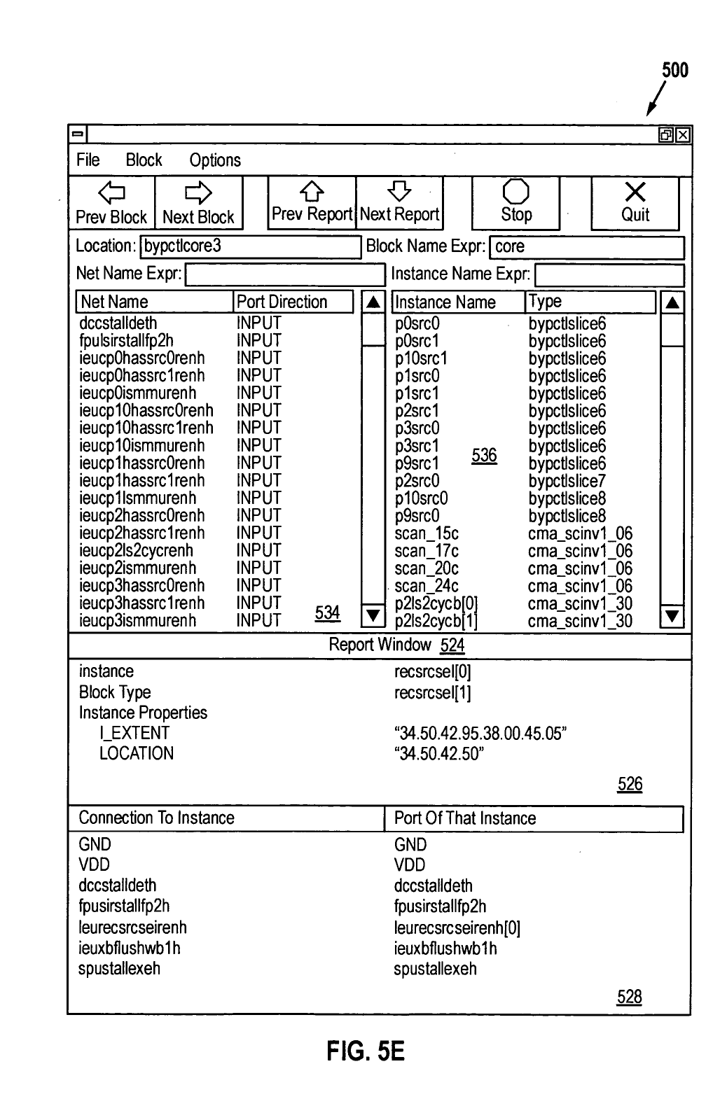

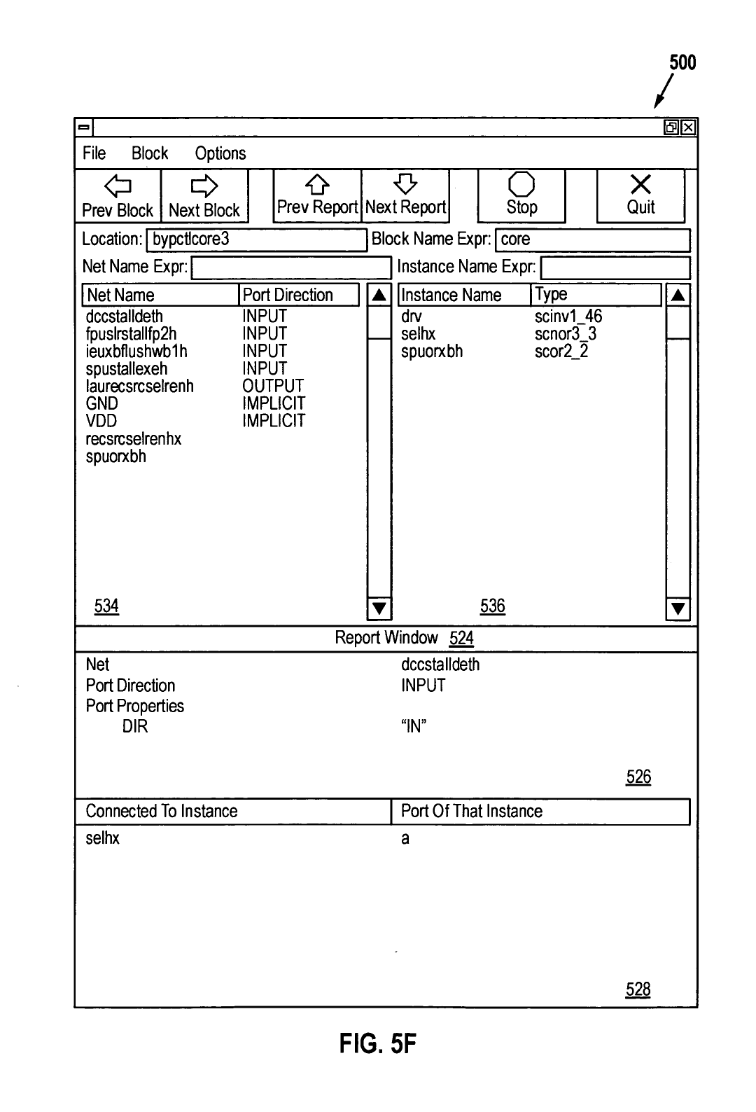

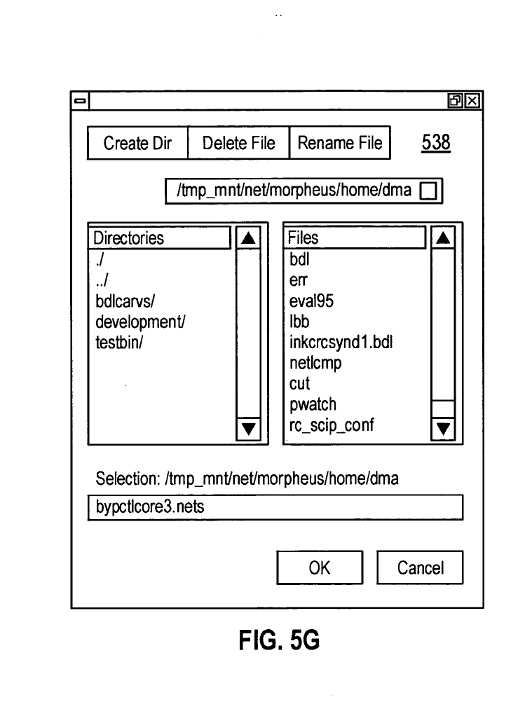

FIGS. 5A-5G depict a number of screen shot renditions associated with a GUI 500 that is effectuated by launching a connectivity browser embodiment of the present invention. Referring in particular to FIG. 5A, GUI 500 is exemplified with a tool bar 502 that include navigational icons such as PREV BLOCK 504, NEXT BLOCK 506, PREV REPORT 508, NEXT REPORT 510, STOP 512, and QUIT 514. In the embodiment shown, GUI 500 supports a command line interface including several portions, thereby providing a more versatile capability to traverse a connectivity database. A LOCATION portion 516 is operable to display and provide a means for changing a current subset of a text-based connectivity database. In the context of the present patent application, a connectivity database's subset is deemed equivalent to a Block Name (e.g., the name associated with a functional unit or circuit block of an IC design such as a microprocessor design). A BLOCK NAME EXPR portion 518 is operable as a means to enter an alphanumeric expression as a pattern-matching criterion with respect to the text-based indicia of all block-level design objects included in the connectivity database. Accordingly, any text string entered in the BLOCK NAME EXPR portion 518 will return a list of Block Names in the connectivity database that match the given string pattern. Likewise, an INSTANCE NAME EXPR portion 520 and a NET NAME EXPR portion 522 are provided for selecting appropriate instance-level and net-level design objects by pattern-matching. A Report Window 524 includes a Summary pane 526 operable to present a summary of the search/navigation results shown in a Results pane 528 where, in general, the results may be listed in one or more separate columns that are independently identified with suitable text-based indicia based on a particular query. Further, the Report Window 524 is operable to show different types of reports, wherein each assigns a different text label to the columns.

By way of illustration, an example of a navigational session will now be set forth below wherein the expression “core” is entered in the BLOCK NAME EXPR portion 518. Upon pressing <enter>, the Report Window 524 presents the results, as a summary as well as a complete listing. As shown in FIG. 5B, the Summary pane 526 indicates that the total number of Blocks that include the expression “core” equals 323, whereas the complete listing is provided in the Results pane 528. A first column 530 therein lists all the Block Names that matched the search expression. A second column 532 associated therewith shows the location of the Block Names in the design database (e.g., a directory path). If the list contains a large number of entries, the Results pane 528 may be scrolled, up or down for scanning.

At this juncture, the user can either go into another Block Name search or can select one of the block names obtained as the result of the previous search set forth above. If the user desires to select one of the search results, it can be effectuated either by entering the specific block name into the LOCATION field 516 or by clicking on the name in the Results pane 528. As shown in FIG. 5C, the design object identified as “bypctlcore3” is entered into the LOCATION field 516, which yields information regarding all the nets and wires contained or used in the selected Block, as shown in a Net pane 534 disposed above the Results Window 524. An Instance pane 536 next to the Net pane 534 lists the Instances and the Block Name that describes the contents of each Instance.

Several options are available to the user at this point. For example, the user could either select the Block Name of a particular Instance shown in the Instance pane 536, thereby navigating to a similar report on a new block. Or, the user could click on an Instance's name to list further properties of the Instance in the Report Window 524. Alternatively, the user may enter an expression into the INSTANCE NAME EXPR field 520, thereby obtaining a report that contains a listing of Instance Names that match the expression. Likewise, a Net Name may be selected from the listing shown in the Net pane 534 or by entering an expression into the NET NAME EXPR field 522.

By way of further illustration, it is assumed that a net-level design object having the Wire Name “dccstalldeth” is selected from the Net pane 534. As depicted in FIG. 5D, Results pane 528 of the Report Window 524 lists the instances that Wire or Net object connects to as well as the specific port of the instances to which the Wire/Net object is coupled. The user may then click on an Instance or on the port of that Instance. If the port is selected, the Block describing that Instance is loaded and the Net inside that new Block is automatically selected. If a particular Instance is selected, however, its properties are then displayed, much like selecting an Instance Name from the Instance pane 536.

FIG. 5E exemplifies the GUI 500 when the Instance identified as “recsrcsel [0]” is selected, which results in a listing of various ports of that Instance in the Results pane 528. At this point, the user may select a particular Port Of Instance from the Results pane 528 to effectuate the loading of a new Block (i.e., the describer of the Instance) and automatically select the net within this new describer. By way of example, when the user clicks on a Port Of Instance identified as “dccstalldeth”, it should be noted that this design object has the same name as the Net object originally selected. This illustrates a frequent design database task for which the connectivity browser of the present invention renders optimal performance: Following a net into the lower levels of the hierarchy to determine its ultimate connectivity. In the example described above, the selected Net goes into the Instance having the indicium “recsrcsel [0]” via port “dccstalldeth”, wherein the Instance is described by Block Name “recsrcsel1” and within that Block, the Net connects to the Instance “selhx” via port “a” as shown in the Results pane 528 of FIG. 5F. The Instance “selhx” is described by the object “scnor3_{—}3”, as shown in the Instance pane 536 therein.

If the user decides to return to a previous point, this may be done by clicking on the PREV BLOCK icon 504 of the tool/task bar 502. Thereafter, the user may want to reselect the Net (by clicking on the PREV REPORT button 508). Thereafter, the user can follow this Net as it connects to many other places in the design, or the user can inquire about different instances, or even different blocks. At different stages of navigation the user may decide to save the contents of the various windows of the GUI 500 to appropriate files, local or otherwise, which may be accomplished by means of a pull-down File menu. Under File→Save dialog box, the user can elect to save the contents of either the Net pane 534, Instance pane 536, or Report Window 524 of the GUI 500. After a selection is made, a Save File dialog box is opened so that the user can navigate the file system and provide a name for the file. FIG. 5G depicts a Save File dialog box 538 where the contents of the Net pane 534 are saved.

Set forth below is a pseudocode embodiment representing the flow of events as the user navigates the core of the GUI-based connectivity browser:

BlockNameEntered( blockName )
{

currentBlock =ReadBlock( blockName );
summaryWindow->Display( currentBlock->info );
netWindow->DisplayNets( currentBlock->nets );
instanceWindow->DisplayInstances ( currentBlock->instanceList );

}
BlockSearchExpressionEntered( blockSearchExpression )
{

blockNameList = FindBlockNames( blockSearchExpression );
summaryWindow->Display( blockNameList->count );
reportWindow->Display( blockNameList );

}
InstanceSearchExpressionEntered( instanceSearchExpression )
{

instanceNameList = currentBlock->FindInstanceNames(

currentBlock->instanceList, instanceSearchExpression );

summaryWindow->Display( instanceNameList->count );
reportWindow->Display( instanceNameList );

}
NetSearchExpressionEntered( )
{

netNameList = currentBlock->FindNetNames( currentBlock->netList,

netSearchExpression );

summaryWindow->Display( netNameList->count );
reportWindow->Display( netNameList );

}
InstanceClicked( instanceName )
{

instance = currentBlock->FindInstance( instanceName );
summaryWindow->Display( instance->info );
reportWindow->Display( instance->connectivity );

}
BlockClicked( blockName )
{

BlockNameEntered( blockName );

}
PinClicked( instanceName, pinName )
{

instance = currentBlock->FindInstance( instanceName );
BlockNameEntered( instance->describer );
# currentBlock now updated
PortClicked( pinName );

}
PortClicked( portName )
{

port = currentBlock->FindPort( portName );
summaryWindow->Display( port->info );
reportWindow->Display( port->connectivity );

}
NetClicked( netName )
{

net = currentBlock->FindNet( netName );
summaryWindow->Display( net->info );
reportWindow->Display( net->connectivity );

}

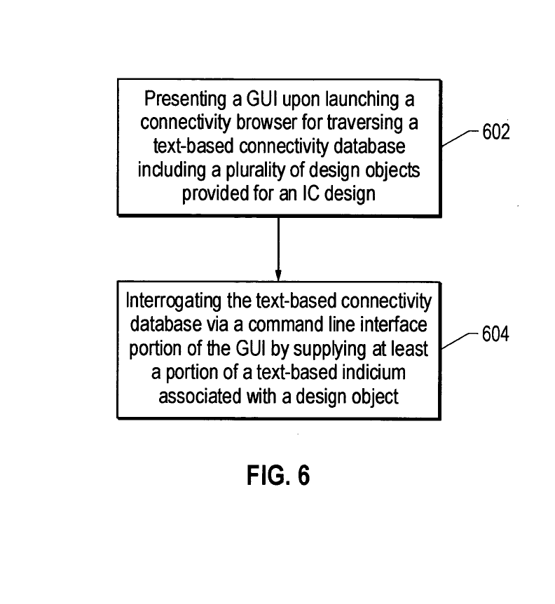

Referring to FIG. 6, depicted therein is an embodiment of a computer-implemented method for navigating through text-based connectivity design information associated with an IC design. As set forth in block 602, a GUI is presented upon launching a connectivity browser that is operable to traverse a text-based connectivity database including a plurality of design objects provided for the IC design. Thereafter, a user may interrogate the text-based connectivity database via a command line interface portion of the GUI by supplying at least a portion of a text-based indicium (e.g., the names or expressions involving a portion of the names) associated with a design object (block 604). In one configuration, the GUI includes an interface portion for selecting a location (i.e., a subset) of the connectivity database from which navigation may commence. As described in detail hereinabove, a specific Block Name may be selected or a Block Name expression may be entered, for example. Upon obtaining the results, Net/Wire list information and associated Instance and Type information may be viewed for the selected Block design object. Additional procedures such as reporting, saving, and executing other optional navigational processes with respect to the selected portion of the connectivity database or launching another navigation session relative to a different portion of the current connectivity database or a new connectivity database may then be effectuated depending on the user. It should be apparent to one skilled in the art that the various blocks set forth herein as part of the computer-implemented method and system for navigating through text-based connectivity design information may be effectuated via hardware, software, firmware, or any combination thereof. Additionally, the software components may be coded in any known or heretofore unknown computer language.

Although the invention has been particularly described with reference to certain illustrations, it is to be understood that the forms of the invention shown and described are to be treated as exemplary embodiments only. Various changes, substitutions and modifications can be realized without departing from the spirit and scope of the invention as defined by the appended claims.

1. A system for navigating through design information associated with an integrated circuit (IC) design, comprising:
a text-based connectivity database structure including a plurality of design objects provided for said IC design; and
a graphical user interface structure supported by a browser engine that provides a command line interface for interrogating said connectivity database using at least a portion of a text-based indicium associated with a design object.

2. The system for navigating through design information associated with an IC design as recited in claim 1, wherein said plurality of design objects are disposed in a hierarchical tree arrangement.

3. The system for navigating through design information associated with an IC design as recited in claim 1, wherein said plurality of design objects include at least one block and said text-based indicium comprises a block name associated with said block.

4. The system for navigating through design information associated with an IC design as recited in claim 1, wherein said plurality of design objects include at least one block and said text-based indicium comprises a block name expression associated with said block.

5. The system for navigating through design information associated with an IC design as recited in claim 1, wherein said plurality of design objects include at least one net and said text-based indicium comprises a net name associated with said net.

6. The system for navigating through design information associated with an IC design as recited in claim 1, wherein said plurality of design objects include at least one instance of a subcircuit and said text-based indicium comprises an instance name associated with said instance.

7. The system for navigating through design information associated with an IC design as recited in claim 1, wherein said plurality of design objects include at least one cell and said text-based indicium comprises a cell name associated with said cell.

8. The system for navigating through design information associated with an IC design as recited in claim 1, wherein said browser engine further supports a plurality of menu-driven dialog boxes for selectively traversing said text-based connectivity database.

9. The system for navigating through design information associated with an IC design as recited in claim 1, wherein said graphical user interface structure includes at least one user interface pane operable to display results obtained responsive to interrogating said text-based connectivity database.

10. A method for navigating through design information associated with an integrated circuit (IC) design, comprising:
presenting a graphical user interface upon launching a connectivity browser, wherein said connectivity browser is operable to traverse a text-based connectivity database including a plurality of design objects provided for said IC design; and
interrogating said text-based connectivity database via a command line interface portion of said graphical user interface by supplying at least a portion of a text-based indicium associated with a design object.

11. The method for navigating through design information associated with an IC design as recited in claim 10, wherein said plurality of design objects are disposed in a hierarchical tree arrangement.

12. The method for navigating through design information associated with an IC design as recited in claim 10, wherein said plurality of design objects include at least one block and said text-based indicium comprises a block name associated with said block.

13. The method for navigating through design information associated with an IC design as recited in claim 10, wherein said plurality of design objects include at least one block and said text-based indicium comprises a block name expression associated with said block.

14. The method for navigating through design information associated with an IC design as recited in claim 10, wherein said plurality of design objects include at least one net and said text-based indicium comprises a net name associated with said net.

15. The method for navigating through design information associated with an IC design as recited in claim 10, wherein said plurality of design objects include at least one instance of a subcircuit and said text-based indicium comprises an instance name associated with said instance.

16. The method for navigating through design information associated with an IC design as recited in claim 10, wherein said plurality of design objects include at least one cell and said text-based indicium comprises a cell name associated with said cell.

17. The method for navigating through design information associated with an IC design as recited in claim 10, wherein said connectivity browser further supports a plurality of menu-driven dialog boxes for selecting different portions of said text-based connectivity database.

18. The method for navigating through design information associated with an IC design as recited in claim 10, wherein said graphical user interface structure includes at least one user interface pane operable to display results obtained responsive to interrogating said text-based connectivity database.

19. A computer platform operable to support a design database environment associated with an integrated circuit (IC) design, comprising:
a database structure including text-based connectivity information relative to a plurality of design objects provided for said IC design; and
a browser engine that supports a graphical user interface structure for interrogating said connectivity database using at least a portion of a text-based indicium associated with a design object.

20. The computer platform operable to support a design database environment associated with an IC design as recited in claim 19, wherein said plurality of design objects are disposed in a hierarchical tree arrangement.

21. The computer platform operable to support a design database environment associated with an IC design as recited in claim 19, wherein said plurality of design objects include at least one block and said text-based indicium comprises a block name associated with said block.

22. The computer platform operable to support a design database environment associated with an IC design as recited in claim 19, wherein said plurality of design objects include at least one block and said text-based indicium comprises a block name expression associated with said block.

23. The computer platform operable to support a design database environment associated with an IC design as recited in claim 19, wherein said plurality of design objects include at least one net and said text-based indicium comprises a net name associated with said net.

24. The computer platform operable to support a design database environment associated with an IC design as recited in claim 19, wherein said plurality of design objects include at least one instance of a subcircuit and said text-based indicium comprises an instance name associated with said instance.

25. The computer platform operable to support a design database environment associated with an IC design as recited in claim 19, wherein said plurality of design objects include at least one cell and said text-based indicium comprises a cell name associated with said cell.

26. The computer platform operable to support a design database environment associated with an IC design as recited in claim 19, wherein said browser engine further supports a plurality of menu-driven dialog boxes for selectively traversing said text-based connectivity database.

27. The computer platform operable to support a design database environment associated with an IC design as recited in claim 19, wherein said graphical user interface structure includes at least one user interface pane operable to display results obtained responsive to interrogating said text-based connectivity database.
